(19) United States
(12) Patent Application Publication
(10) Pub. No.: US 2009/0103718 A1
(43) Pub. Date: Apr. 23, 2009

(54) ENCRYPTION AND DECRYPTION METHODS

(75) Inventor: Rui-Hwa CHEN, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: VIA TECHNOLOGIES, INC., Taipei (TW)

(21) Appl. No.: 12/185,214

(22) Filed: Aug. 4, 2008

(30) Foreign Application Priority Data
Oct. 17, 2007 (TW) 96138823

(51) Int. Cl. H04L 9/06

(52) U.S. Cl. 380/29

(57) ABSTRACT

Encryption methods are provided. A data block is selected from a plurality of data blocks. A sentry block is determined. The selected data block is encrypted according to the sentry block to obtain a cipher text. The cipher text is used as the sentry block for encrypting the next data block.

### CROSS REFERENCE TO RELATED APPILCATIONS

This Application claims priority of Taiwan Patent Application No. 096138823, filed on Oct. 17, 2007, the entirety of which is incorporated by reference herein.

### BACKGROUND OF THE INVENTION

1. Field of the Invention

The disclosure relates generally to encryption and decryption methods, and, more particularly to methods that encrypt and decrypt data using the content itself.

2. Description of the Related Art

In cryptography, symmetric or asymmetric encryption/decryption mechanisms are mostly adopted. For example, the symmetric encryption/decryption algorithms can be RC4, DES and AES algorithms. For symmetric encryption/decryption algorithms, a same key is used in data encryption and decryption. The asymmetric encryption/decryption algorithms can be an RSA algorithm. For the asymmetric encryption/decryption algorithms, a public key is used in data encryption, and a private key is used in data decryption. For symmetric and asymmetric encryption/decryption algorithms, a major issue is to make sure the key is securely passed. In general, the asymmetric encryption/decryption algorithm is securer than the symmetric encryption/decryption algorithm; however, it is also complex.

Some encryption/decryption algorithms, such as substitution encryption/decryption algorithms, do not use the key during data encryption and decryption. FIG. 1 is a schematic diagram illustrating a substitution encryption/decryption algorithm. As shown in FIG. 1, a letter is substituted by another letter according to the substitution encryption/decryption algorithm to generate a cipher. For example, A is substituted by V, B is substituted by G, C is substituted by S, D is substituted by Q, and the like. Unfortunately, the cipher can be cracked in the situation of frequent analysis, so the security is reduced.

### BRIEF SUMMARY OF THE INVENTION

Encryption and decryption methods are provided.

In an embodiment of an encryption method, a data block is selected from a plurality of data blocks. A sentry block is determined. The selected data block is encrypting as a cipher text according to the sentry block and the selected data block.

In an embodiment of a decryption method, a data block is selected from a plurality of data blocks. A sentry block is determined. The selected data block is decrypted as a cipher block according to the sentry block and the selected data block.

Encryption and decryption methods may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating a substitution encryption/decryption algorithm;

FIG. 2 is a flowchart of an embodiment of an encryption method according to the invention;

FIG. 3 is a flowchart of an embodiment of a decryption method according to the invention;

FIG. 4A is an encryption example, wherein the number of sentry blocks is 1, and the encryption is an XOR operation performed to the data block;

FIG. 4B is a decryption example for the cipher text generated in FIG. 4A;

FIG. 5A is an encryption example, wherein the number of sentry blocks is 2, and the encryption is an XOR operation performed to the data block; and

FIG. 5B is a decryption example for the cipher text generated in FIG. 5A.

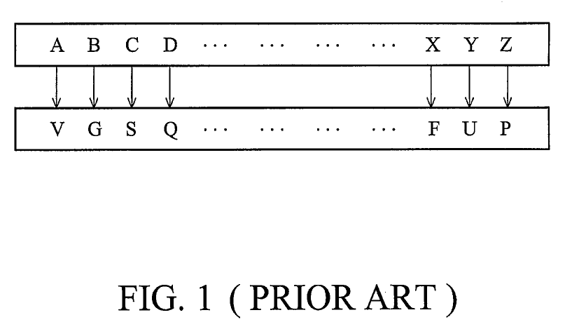

### DETAILED DESCRIPTION OF THE INVENTION

Encryption and decryption methods are provided.

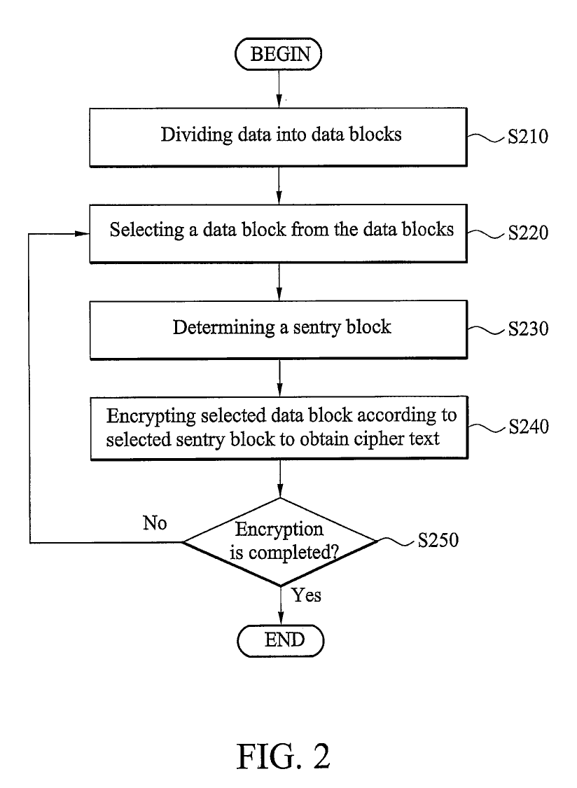

FIG. 2 is a flowchart of an embodiment of an encryption method according to the invention. In this embodiment, data is encrypted using the content itself.

In step S210, data is divided into a plurality of data blocks. It is understood that each data block may have the identical length, such as 1 bit, 1 byte, or other size. In some embodiments, the respective data blocks may have different lengths. In step S220, selecting a data block for encrypting. In step S230, determining a sentry block. It is understood that, in some embodiments, the sentry block is a key of other data blocks for encrypting. In some embodiments, the sentry block is the same with the selected data block. In some embodiments, the sentry block is obtained from either a logic operation or an encryption/decryption algorithm of data blocks. In some embodiments, the sentry block is the previous encrypted data block (i.e. a cipher text) which contributes to the complexity of encryption.

In step S240, encrypting the selected data block according to the sentry block to obtain a cipher text. It is understood that the cipher text may be obtained from either a logic operation, such as XOR, AND, OR, and NOT, or an encryption/decryption algorithm, such as a substitution encryption/decryption algorithm, a symmetric encryption/decryption algorithm, or an asymmetric encryption/decryption algorithm of the selected data block and the sentry block.

In step S250, determining whether the encryption process is completed. It is noted that, in some embodiments, the encryption process is completed as long as all data blocks of the data are encrypted. In some embodiments, the encryption process is completed while a certain number of the data blocks are encrypted. If the encryption process is completed (Yes in step S250), the procedure ends. If the encryption process is not completed (No in step S250), backs to step 220. Then, another data block is selected for encrypting.

It is understood that the selection and order of the sentry blocks, the selection and order of the data blocks, and related information can be recorded, and can be used as reference in data decryption.

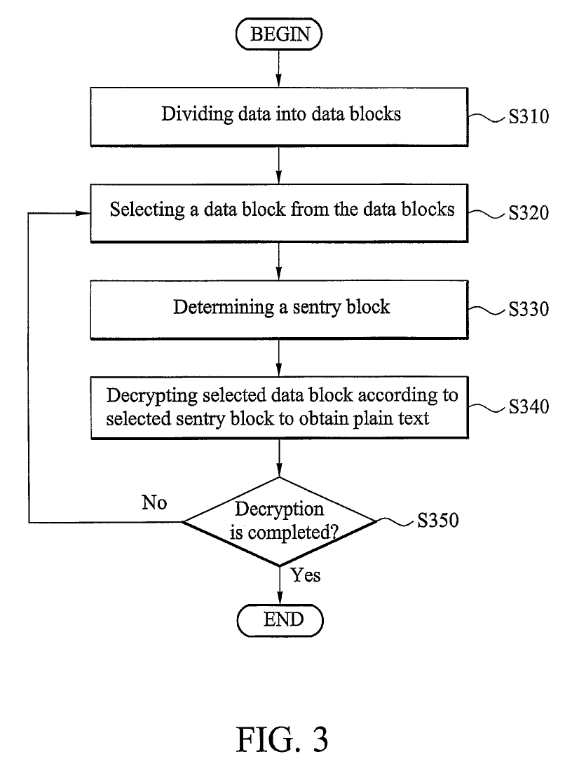

FIG. 3 is a flowchart of an embodiment of a decryption method according to the invention. In this embodiment, data is decrypted using the content itself

In step S310, data is divided into a plurality of data blocks. It is understood that each data block may have the identical length, such as 1 bit, 1 byte, or other size. In some embodiments, the respective data blocks may have different lengths. In step S320, selecting a data block for decrypting. In step S330, determining a sentry block. It is understood that, in some embodiments, the sentry block is a key of other data blocks for encrypting. In some embodiments, the sentry block is the same with the selected data block. In some embodiments, the sentry block is obtained from either a logic operation or an encryption/decryption algorithm of data blocks. In some embodiments, the sentry block is the previous decrypted data block (i.e. a plain text) which contributes to the complexity of decryption.

In step S340, decrypting the selected data block according to the sentry block to obtain a plain text. It is understood that the plain text may be obtained from either a logic operation such as XOR, AND, OR, and NOT, or an encryption/decryption algorithm, such as a substitution encryption/decryption algorithm, a symmetric encryption/decryption algorithm, or an asymmetric encryption/decryption algorithm of the selected data block and the sentry block.

In step S350, determining whether the decryption process is completed. It is noted that, in some embodiments, the decryption process is completed as long as all data blocks of the data are decrypted. In some embodiments, the decryption process is completed while a certain numbers of the data blocks are decrypted. If the decryption process is completed (Yes in step S350), the procedure ends. If the decryption process is not completed (No in step S350), backs to step 320. Then, another data block is selected for decrypting.

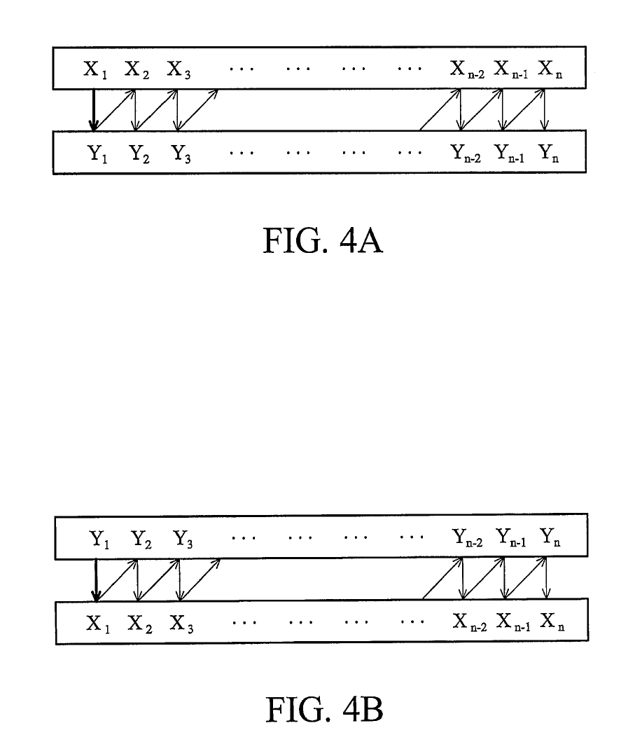

FIG. 4A is an example of encrypting data blocks as cipher texts. Assume performing an XOR operation as encryption. As shown in FIG. 4A, data blocks are X1, X2, X3, . . . , and Xn; and the corresponding cipher texts are Y1, Y2, Y3, . . . , and Yn. In this example, assume data block X1 is selected and the sentry block is equal to X1; therefore, the data block X1 is encrypted as the cipher text Y1=X1 is obtained. Next, selecting the data block X2 for encrypting, and using the previous cipher text Y1 as the sentry block; therefore, the cipher text Y2(Y2=Y1⊕(X2) is obtained . Then, selecting the data block X3 for encrypting, and using the previous cipher text Y2 as the sentry block; therefore, the cipher text Y3(Y3=Y2⊕X3) is obtained. The procedures are repeated until data block Xn is lastly selected, and the cipher text Yn(Yn=Yn−1⊕Xn) is obtained.

FIG. 4B is an example for decrypting data blocks as plain texts. Assume performing an XOR operation as encryption. As shown in FIG. 4B, data blocks are Y1, Y2, Y3, . . . , and Yn; and the corresponding plain texts are X1, X2, X3, . . . , and Xn. In this example, assume data block Y1 is selected and the sentry block is equal to Y1; therefore, the data block Y1 is decrypted as the plain text Y1=X1 is obtained. Next, selecting the data block Y2 for decrypting, and using the previous plain text X1 as the sentry block; therefore, the plain text X2(X2=X1⊕Y2) is obtained. Then, selecting the data block Y3 for decrypting, and using the previous plain text X2 as the sentry block; therefore, the plain text Y3(Y3=Y2⊕X3) is obtained. The procedures are repeated until data block Yn is lastly selected, and the plain text Xn(Xn=Xn−1⊕Yn) is obtained.

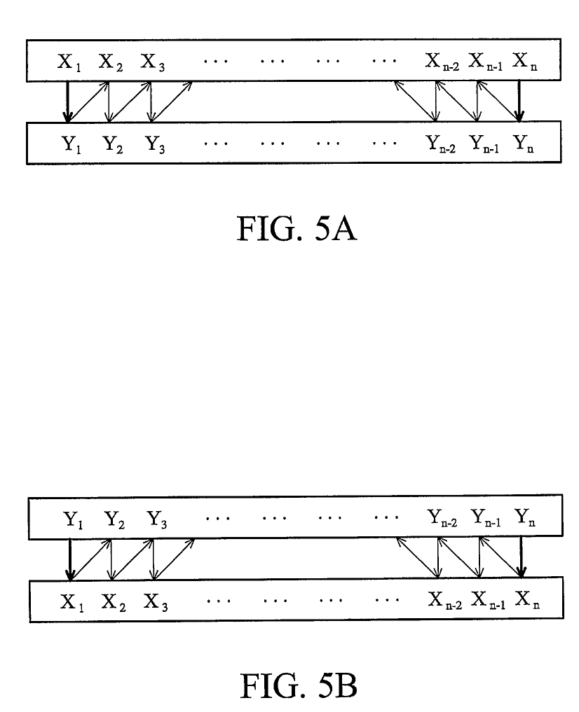

FIG. 5A is an example of encrypting data blocks as cipher texts. Assume performing an XOR operation as encryption. As shown in FIG. 5A, data blocks are X1, X2, X3, . . . , and Xn; and cipher texts are Y1, Y2, Y3, . . . , and Yn. In this example, assume data blocks X1 and Xn are simultaneously selected, and the corresponding sentry blocks are respectively equal to X1 and X2. Therefore, the data block X1 and X2 are respectively encrypted, and the corresponding cipher texts Y1=X1 and Yn=Xn are obtained. It is understood that the encryption process for the data can be started from both ends of data blocks. Next, selecting data block X2 and Xn−1 for encrypting, and using the previous cipher texts Y1 and Yn as the sentry blocks. As a result, the cipher text Y2(Y2=Y1⊕X2) and the cipher text Yn−1(Yn−1=Yn⊕Xn−1) are both obtained. Then, selecting data block X3 and Xn−2 for encrypting, and using the previous cipher texts Y2 and Yn−1 as the sentry block. The procedures are repeated until all cipher texts are obtained.

FIG. 5B is an example of decrypting data blocks as the plain texts. Assume performing an XOR operation as encryption. As shown in FIG. 5B, data blocks are Y1, Y2, Y3, . . . , and Yn; and plain texts are X1, X2, X3, . . . , and Xn. In this example, assume data blocks Y1 and Yn are simultaneously selected, and the corresponding sentry blocks are respectively equal to X1 and X2. Therefore, the data block Y1 and Y2 are respectively decrypted, and the corresponding plain texts X1=Y1 and Xn=Yn are obtained. Similarly, the decryption process for the data can be started from both ends of data blocks. Next, selecting data block Y2 and Yn−1 for decrypting, and using the previous plain texts X1 and Xn as the sentry blocks. As a result, the plain text X2(X2=X1⊕Y2) and the plain text Xn−1(Xn−1=Xn⊕Yn−1) are both obtained. Then, selecting data block Y3 and Yn−2 for decrypting, and using the previous plain texts X2 and Xn−1 as the sentry blocks. The procedures are repeated until all plain texta are obtained.

Encryption and decryption, or certain aspects or portions thereof, may take the form of a program code (i.e., executable instructions) embodied in tangible media, such as products, floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A method for encrypting a plurality of data blocks as a plurality of cipher texts, comprising:
selecting one data block from the data blocks for encrypting;
determining a sentry block; and
encrypting the selected data block as a cipher text according to the sentry block and the selected data block.

2. The method of claim 1 wherein the sentry block is substantially equal to the selected data block.

3. The method of claim 1 wherein the sentry block is obtained from a logic operation of the selected data block.

4. The method of claim 1 wherein the sentry block is obtained by performing an encryption/decryption algorithm to the selected data block.

5. The method of claim 1 wherein the sentry block is substantially equal to the cipher text.

6. The method of claim 1 wherein the cipher text is obtained by performing a logic operation to the sentry block and the selected data block.

7. The method of claim 1 wherein the cipher text is obtained by performing an encryption/decryption algorithm to the sentry block and the selected data block

8. The method of claim 7 wherein the encryption/decryption algorithm comprises a substitution encryption/decryption algorithm, a symmetric encryption/decryption algorithm, or an asymmetric encryption/decryption algorithm.

9. The method of claim 1 wherein length of the data blocks is either identical or different.

10. A method for decrypting a plurality of data blocks as a plurality of plain texts, comprising:
selecting one data block from the data blocks for decrypting;
determining a sentry block; and
decrypting the selected data block as a plain text according to the sentry block and the selected data block.

11. The method of claim 10 wherein the sentry block is substantially equal to the selected data block.

12. The method of claim 10 wherein the sentry block is obtained by performing a logic operating to the selected data block.

13. The method of claim 10 wherein the sentry block is obtained by performing an encryption/decryption algorithm to the selected data block.

14. The method of claim 10 wherein the sentry block is substantially equal to the plain text.

15. The method of claim 10 wherein the plain text is obtained by performing a logic operation to the sentry block and the selected data block.

16. The method of claim 10 wherein the plain text is obtained by performing an encryption/decryption algorithm to the sentry block and the second data block

17. The method of claim 10 wherein length of the data blocks is either identical or different.
